(19) United States
(12) Patent Application Publication
(10) Pub. No.: US 2010/0019768 A1
(43) Pub. Date: Jan. 28, 2010

(54) APPARATUS AND METHOD FOR METAL DETECTING

(75) Inventors: QIANG QIN, Shenzhen City (CN); TIAN-YOU LIU, Shenzhen City (CN); LIAN-ZHONG GONG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/203,091

(22) Filed: Sep. 2, 2008

(30) Foreign Application Priority Data
Jul. 25, 2008 (CN) 200810303078.5

(51) Int. Cl. G01V 3/10

(52) U.S. Cl. 324/329

(57) ABSTRACT

A metal detecting apparatus includes a sensor, a current signal outputting circuit, a transforming circuit, and a micro processing unit (MPU). The sensor is configured to sense metal objects in close proximity. The current signal outputting circuit is configured to generate alternative current signals. The alternative current signals are converted to digital voltage signals via the transforming circuit. The MPU is configured to obtain a specific frequency value of the alternative current signals according to the digital voltage signals. When the sensor senses a metal object in close proximity, the specific frequency value obtained by the MPU changes. The MPU is configured to determine if a metal object has been detected by determining if the obtained specific frequency value has changed.

### BACKGROUND

1. Field of the Invention

The present invention relates to the field of metal detection, and particularly, to an apparatus and method for detecting metal objects.

2. Description of the Related Art

Metal detecting apparatuses detect the presence of metal objects in close proximity without any physical contact. Metal detecting apparatuses are commonly used in security inspections, such as checking passengers at airports and checking visitors in highly protected buildings or installations. Metal detecting apparatuses are also used for determining whether metal objects have been mounted correctly in an assembly. However, typical metal detecting apparatuses, such as inductive proximity sensors, are very complicated and expensive.

What is desired, therefore, is a metal detecting apparatus to over come the above-described shortcoming.

### BRIEF DESCRIPTION OF THE DRAWINGS

FIG. 1 is a block diagram of an embodiment of a detecting apparatus.

FIG. 2 is a circuit diagram of the detecting apparatus of FIG. 1.

FIG. 3 is a flow chart of an embodiment of a metal detecting method.

### DETAILED DESCRIPTION OF THE EMBODIMENTS

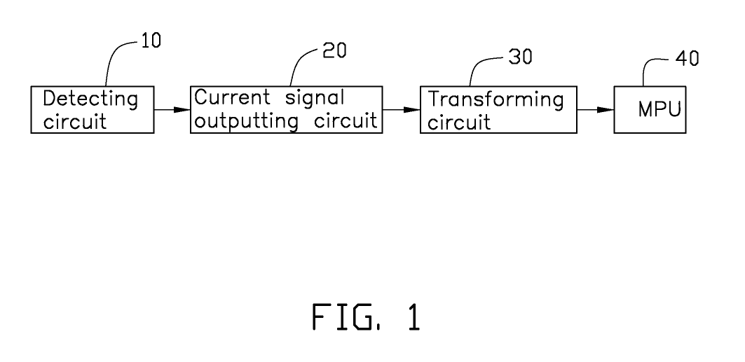

Referring to FIG. 1, an embodiment of a metal detecting apparatus in includes a detecting circuit 10, a current signal outputting circuit 20, a transforming circuit 30, and a micro processing unit (MPU) 40 connected in series.

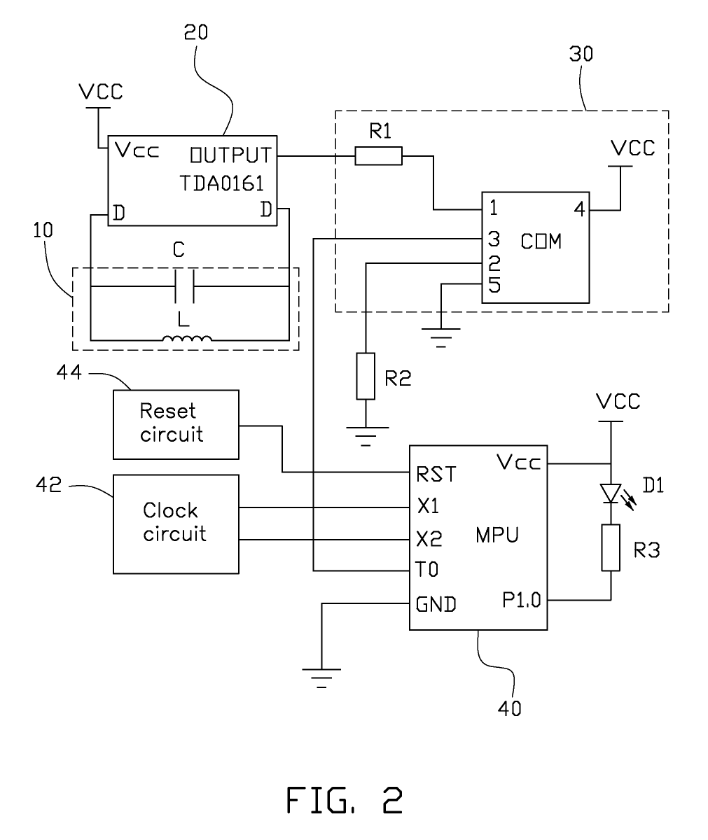

Referring to FIG. 2, the detecting circuit 10 includes a capacitor C and an inductance coil L functioning as a sensor. The current signal outputting circuit 20 may be a TDA0161 type integrated chip including a power terminal Vcc, two detecting terminals D, and an output terminal OUTPUT. The power terminal Vcc of the current signal outputting circuit 20 is connected to a power supply VCC. The inductance coil L and the capacitor C are connected in parallel between the two detecting terminals D. The transforming circuit 30 includes a resistor R1 and a comparator COM. The comparator COM includes a first input terminal 1, a second input terminal 2, an output terminal 3, a power terminal 4 connected to the power supply VCC, and a ground terminal 5 grounded. The first input terminal 1 is connected to the output terminal OUTPUT via the first resistor R1. The second input terminal 2 is grounded via a second resistor R2. The output terminal 3 is connected to the MPU 40. The MPU 40 includes a power terminal Vcc connected to the power supply VCC, a reset terminal RST coupled to a reset circuit 44, two clock terminals X1 and X2 coupled to a clock circuit 42, an input/output (I/O) terminal P1.0, a ground terminal GND grounded, and a count terminal T0 connected to the output terminal 3. The I/O terminal P1.0 is connected to the power supply VCC via a third resistor R3 and a light-emitting diode (LED) D1 connected in series.

An oscillator (not shown) may be integrated in the integrated chip 20. The oscillator is connected to the inductance coil L. During use, the integrated chip 20 generates alternative current (AC) signals at a specific frequency value via self-oscillation of the oscillator. The AC signals pass through the inductance coil L, and an alternative magnetic field is generated by the current flowing through the inductance coil L. The AC signals are sampled by the first resistor R1 and transformed into analog voltage signals. The analog voltage signals are received by the input terminal 1 and converted into digital voltage signals by being compared to a reference voltage, which is the voltage at the input terminal 2 of the comparator COM. The count terminal T0 is configured to receive and take a count of the digital voltage signals. Thus, a frequency value may be obtained by the MPU 40 according to the digital voltage signals.

If there is no metal in close proximity to the inductance coil L, the frequency value obtained by the MPU 40 is substantially equal to the specific frequency value. If the inductance coil L detects a metal in close proximity, particularly, when the alternative magnetic field of the inductance coil L moves across the metal, an eddy current is induced in the metal, creating an eddy current magnetic field near the metal. The eddy current magnetic field opposes the change of the magnetic field, thereby altering the frequency of the AC signals. Thus, the specific frequency value obtained by the MPU 40 changes. If the specific frequency value is changed, the I/O pin P1.0 outputs a low level signal to turn on the LED D1 to indicate that a metal object has been detected. If the specific frequency value remains unchanged, the I/O pin P1.0 outputs no signal, and the LED D1 remains off.

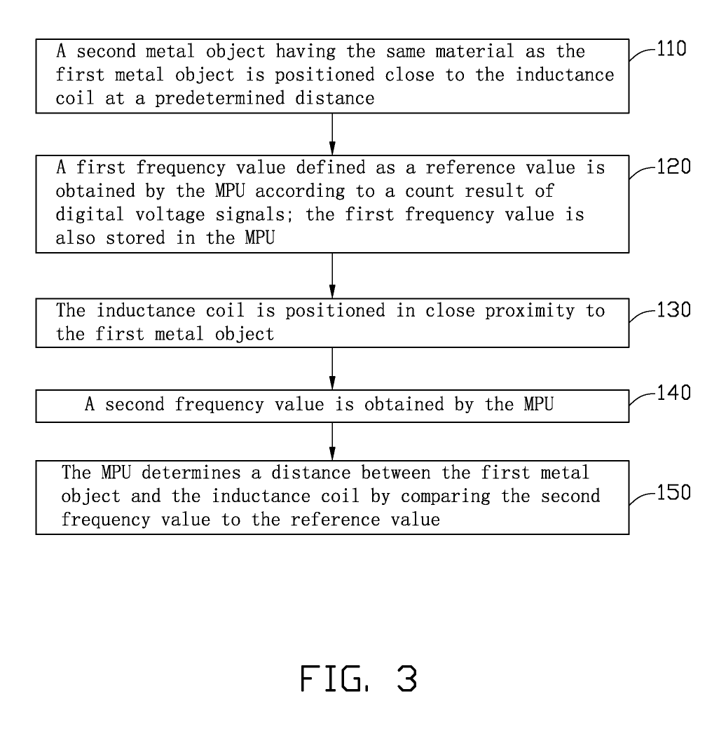

In one embodiment, if a metal object is detected, the frequency of the AC signals outputted from the integrated chip 20 increases as the detected metal object moves closer to the inductance coil L. Accordingly, the MPU 40 obtains a greater frequency value. Thus, by comparing a distance between the detected metal object and the inductance coil L at a predetermined distance, the MPU 40 can determine if the detected metal object is within a required range. For example, the MPU 40 can determine if a metal object has been mounted correctly. Referring to FIG. 3, is a method using the above mentioned apparatus for detecting the distance between a first metal object of fixed material and the inductance coil L. Depending on the embodiment, certain of the steps described below may be removed, others may be added, and the sequence of steps may be altered.
Step 110: a second metal object having the same material as the first metal object is positioned close to the inductance coil L at a predetermined distance.
Step 120: a first frequency value defined as a reference value is obtained by the MPU 40 according to a count result of digital voltage signals; the first frequency value is also stored in the MPU 40.
Step 130: the inductance coil L is positioned in close proximity to the first metal object.
Step 140: a second frequency value is obtained by the MPU 40.
Step 150: the MPU 40 determines a distance between the first metal object and the inductance coil L by comparing the second frequency value to the reference value.

In step 150, if the second frequency value is greater than the reference value, the distance between the first metal object and the inductance coil L is shorter than the predetermined distance. If the second frequency value is less than the reference value, the distance between the first metal object and the inductance coil L is greater than the predetermined distance. If the second frequency value is equal to the reference value, the distance between the first metal object and the inductance coil L is equal to the predetermined distance. The position of the first metal object can be repeated by resetting the predetermined distance and obtaining comparison results again.

In one embodiment, a display may be connected to the MPU 40 to display comparison results and the position of the metal object.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A metal detecting apparatus comprising:
a sensor configured to sense a metal object in close proximity;
a current signal outputting circuit configured to generate alternative current signals;
a transforming circuit configured to convert the alternative current signals to digital voltage signals; and
a micro processing unit configured to obtain a specific frequency value of the alternative current signals according to the digital voltage signals;
wherein upon a condition that the sensor senses a metal object in close proximity, the specific frequency value obtained by the micro processing unit changes; the micro processing unit is further configured to determine if the metal object is in close proximity by determining if the obtained specific frequency value has changed.

2. The metal detecting apparatus of claim 1, wherein the current signal outputting circuit is a TDA0161 type integrated chip comprising two detecting terminals and an output terminal connected to the transforming circuit.

3. The metal detecting apparatus of claim 2, further comprising a detecting circuit comprising the sensor and a capacitor connected in parallel between the two detecting terminals.

4. The metal detecting apparatus of claim 1, wherein the sensor is an inductance coil.

5. The metal detecting apparatus of claim 1, wherein the transforming circuit comprises a first resistor and a comparator; the first resistor samples the alternative current signals and transforms the alternative current signals to analog voltage signals; the analog voltage signals are converted to the digital voltage signals by the comparator.

6. The metal detecting apparatus of claim 5, wherein the transforming circuit further comprises a second resistor; the comparator comprises a first comparator input terminal, a second comparator input terminal, and a comparator output terminal; the first comparator input terminal is connected to the output terminal of the current signal outputting circuit via the first resistor, the second comparator input terminal is grounded via the second resistor; and the comparator output terminal is connected to the micro processing unit.

7. The metal detecting apparatus of claim 1, wherein the micro processing unit comprises a count terminal configured to receive and take a count of the digital voltage signals; a frequency value is obtained by the micro processing unit according to the count of the digital voltage signals.

8. The metal detecting apparatus of claim 1, wherein the micro processing unit comprises an input/output terminal connected to a power supply via a light emitting diode; the light emitting diode is configured to indicate if the metal object has been detected.

9. A metal detecting method using a metal detecting apparatus comprising a sensor configured to sense a metal object in close proximity, a current signal outputting circuit configured to generate alternative current signals, a transforming circuit configured to convert the alternative current signals to digital voltage signals, and a micro processing unit configured to obtain a specific frequency value of the alternative current signals according to the digital voltage signals, the method comprising:
locating a prepared metal object close to the sensor at a predetermined distance to generate first alternative current signals;
storing a frequency value of the first alternative current signals;
generating second alternative current signals by sensing a desired metal object, wherein the desired metal object is made of the same material as the prepared metal;
obtaining a comparison between a frequency value of the second alternative current signals and the stored frequency value; and
processing a distance between the desired metal object and the sensor according to the compared result.

10. The method of claim 9, wherein the sensor is an inductance coil.

11. The method of claim 9, further comprising sampling the first and second alternative current signals, and transforming the first alternative current signals to first digital voltage signals and second alternative current signals to second digital voltage signals.

12. The method of claim 11, wherein the frequency values of the first alternative current signals is obtained by counting the first digital voltage signals, and second alternative current signals is obtained by counting the second digital voltage signals.

13. The method of claim 9, wherein the processing step further comprises: obtaining a logical relationship between the predetermined distance and the distance between the desired metal object and the sensor.

14. The method of claim 13, wherein upon a condition that the frequency value of the second alternative current signals is greater than the stored frequency value, the distance between the desired metal object and the sensor is shorter than the predetermined distance; upon a condition that the frequency value of the second alternative current signals is less than the stored frequency value, the distance between the desired metal object is longer than the predetermined distance; upon a condition that the frequency value of the second alternative current signals is substantially equal to the stored frequency value, the distance between the desired metal object and the sensor is equal to the predetermined distance.

15. The method of claim 9, further comprising displaying the comparison via a display connected to the micro processing unit.
